(19) United States
(12) Patent Application Publication
(10) Pub. No.: US 2025/0196612 A1
(43) Pub. Date: Jun. 19, 2025

(54) MOTOR SYSTEM WITH STATOR WINDINGS CONNECTED TO MULTIPLE DRIVES

(71) Applicant: HL MANDO CORPORATION, Gyeonggi-do (KR)

(72) Inventors: Md Sariful ISLAM, Bay City, MI (US); Amina SHRESTHA, Bay City, MI (US); Mohammad ISLAM, Bay City, MI (US)

(21) Appl. No.: 18/540,845

(22) Filed: Dec. 14, 2023

(51) Int. Cl. B60K 7/00; H02K 1/16; H02K 1/276; H02K 3/28; H02K 11/33

(52) U.S. Cl. CPC B60K 7/0007; H02K 1/16; H02K 1/276; H02K 3/28; H02K 11/33

(57) ABSTRACT

A motor system may comprise: a plurality of drives configured to drive a plurality of stator windings; a stator assembly comprising the plurality of stator windings arranged along a circumference of a stator core, wherein each of the plurality of drives is evenly connected to one of the plurality of stator windings over the circumference of the stator core; and a rotor assembly configured to be rotatable relative to the stator assembly. Each of the plurality of drives is connected to at least one of stator windings located at one half side of the stator core among the plurality of stator windings and each of the plurality of motor drives is connected to at least one of stator windings located at another half side of the stator core among the plurality of stator windings. Each of the plurality of motor drivers comprises an inverter.

### TECHNICAL FIELD

Various embodiments of the present disclosure relate in general to an electric motor, and more particularly, to a structure and components of stator and rotor assemblies of an electric motor.

### BACKGROUND

A motor is a well-known electrical machine that converts electrical energy into mechanical energy using magnetic field linkage. For example, an electric motor may feature a rotor with permanent magnets and a stator. Electric motors are known for their high efficiency. The electric motors are also known for their durability, controllability, and absence of electrical sparking. Due to their advantages the electric motors are widely used in automobile applications.

The electric motor may have an inverter or motor controller comprising switches such as semiconductors that support the provision of alternating current outputs for one or more phases of the electric motor. However, the inverter or motor controller may fail in an open state (i.e., discontinuity) or a closed state (i.e., short circuit) with respect to the output terminals of the switches. During operation of the motor, if one or more switches included in the inverter or motor controller fail in either the open state or the closed state, the electric motor may be difficult to control, and damage can occur to the controller, the motor, or both. Specially, in the case of the open-circuit fault, the electric motor may be in a limp operation mode. The faults in the inverter or motor controller may cause an uncontrolled torque in the motor.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, a motor system may comprise: a plurality of drives configured to drive a plurality of stator windings; a stator assembly comprising the plurality of stator windings arranged along a circumference of a stator core, wherein each of the plurality of drives is evenly connected to one of the plurality of stator windings over the circumference of the stator core; and a rotor assembly configured to be rotatable relative to the stator assembly. For example, each of the plurality of drives may be connected to at least one of stator windings located at one half side of the stator core among the plurality of stator windings and each of the plurality of motor drives may be connected to at least one of stator windings located at another half side of the stator core among the plurality of stator windings. As another example, the adjacently positioned stator windings may be connected to different motor drivers, respectively, among the plurality of motor drivers.

Each of the plurality of drives may comprise an inverter.

The stator assembly may include a stator core having a plurality of stator slots, and one of the stator windings at least partially disposed in one of the stator slots may be connected to one of the plurality of drives which is not connected to two others of the stator windings at least partially disposed in two others of the stator slots located adjacent to the one of the stator slots.

The plurality of stator windings may be configured to multi-phases, and stator windings configured for a same phase among the plurality of stator winding may be evenly spaced apart from each other.

The plurality of drives may comprise first and second drives, the plurality of stator windings may comprise first stator windings connected to the first drive and second stator windings connected to the second drive, and the first stator windings connected to the first drive and the second stator windings connected to the second drive may be alternatively disposed.

The plurality of drives may comprise first and second drives, the plurality of stator windings may configured for three phases including first, second, and third phases, and a first winding connected to the first drive and configured for the first phase, a second winding connected to the second drive and configured for the first phase, a third winding connected to the first drive and configured for the second phase, a fourth winding connected to the second drive and configured for the second phase, a fifth winding connected to the first drive and configured for the third phase, and a sixth winding connected to the second drive and configured for the third phase may be arranged in turn repeatedly in a stator core of the stator assembly.

The rotor assembly may comprises a plurality of reluctance rotor segments including a first reluctance rotor segment and a second reluctance rotor segment which are axially stacked relative to each other.

One or more flux barriers included in the first reluctance rotor segment may have different shapes from one or more flux barriers included in the second reluctance rotor segment.

The first reluctance rotor segment may include one or more permanent magnets in one or more flux barriers included in the first reluctance rotor segment, and the second reluctance rotor segment may not include the one or more permanent magnets in one or more flux barriers included in the second reluctance rotor segment.

Material different from a rotor core of the second reluctance rotor segment may be disposed in one or more flux barriers included in the second reluctance rotor segment.

The second reluctance rotor may include one or more flux barriers formed with an air gap.

The plurality of drives may be configured to provide currents, which are with a phase shift between each other, to the plurality of stator windings.

Currents of the adjacently positioned stator windings not connected to the same driver may have a phase shift between each other.

According to various embodiments of the present disclosure, a vehicle may comprise: one or more road wheels configured to cause the vehicle to move; a steering wheel configured to generate an input for controlling the one or more road wheels; a brake assembly configured to operate a vehicle brake associated with the one or more road wheels; and one or more motors operatively connected to one or more of the one or more road wheels, the steering wheel and the brake assembly, at least one of the motors comprising: a plurality of drives configured to drive a plurality of stator windings; a stator assembly comprising the plurality of stator windings arranged along a circumference of a stator core, wherein each of the plurality of drives is evenly connected to one of the plurality of stator windings over the circumference of the stator core; and a rotor assembly configured to be rotatable relative to the stator assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a horizontal cross-sectional view of a motor according to an exemplary embodiment of the present disclosure;

FIG. 2 is a vertical cross-sectional view of a motor according to an exemplary embodiment of the present disclosure;

FIG. 3A is a cross-sectional view of a permanent-magnet-assist reluctance type rotor segment of a rotor assembly according to an embodiment of the present disclosure;

FIG. 3B is a cross-sectional view of a reluctance type rotor segment of a rotor assembly according to an embodiment of the present disclosure;

FIG. 4 is a schematic diagram of a motor system according to an embodiment of the present disclosure;

FIG. 5A is a conceptual diagram for illustrating stator wiring configuration and arrangement according a first embodiment of the present disclosure;

FIG. 5B is a conceptual diagram for illustrating stator wiring configuration and arrangement according a second embodiment of the present disclosure;

FIG. 6A is a graph for showing inductance profile under a fault condition in one of inverters according to a first embodiment of the present disclosure;

FIG. 6B is a graph for showing inductance profile under a fault condition in one of inverters according to a second embodiment of the present disclosure;

FIG. 7A is a graph for illustrating a motor torque with respect to a motor speed under open circuit and short circuit according to a first embodiment of the present disclosure;

FIG. 7B is a graph for illustrating a motor torque with respect to a motor speed under open circuit and short circuit according to a second embodiment of the present disclosure;

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

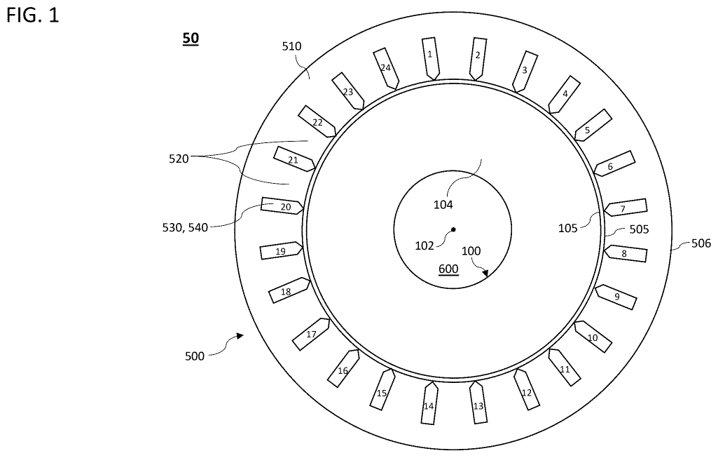

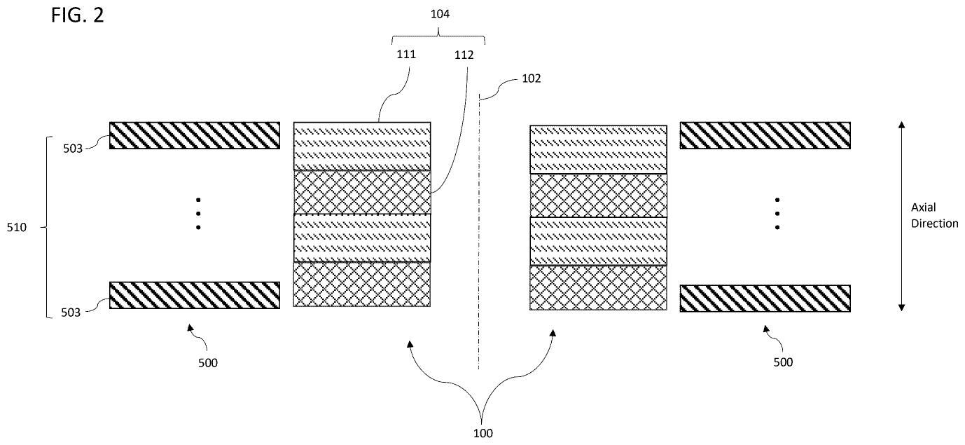

FIG. 1 is a horizontal cross-sectional view of a motor and FIG. 2 is a vertical cross-sectional view of a motor according to an exemplary embodiment of the present disclosure.

A motor 50 includes a rotor assembly 100 and a stator assembly 500. The rotor assembly 100 is disposed for rotation within, and relatively to, the stator assembly 500. The rotor assembly 100 may be rotatably seated on or fixed to a rotor shaft 600. Alternatively, the rotor assembly 100 may be disposed outside the stator assembly 500 to define an exterior rotor motor. The rotor assembly 100 and the stator assembly 500 each may be disposed about and extend along a central axis 102. The rotor assembly 100 may be disposed concentric with the stator assembly 500.

The rotor assembly 100 may include the rotor core 104. For example, the rotor core 104 is disposed on the rotor shaft 600, and the outer surface 105 of the rotor core 104 may be spaced apart from an inner surface 505 of the stator core 510 by, for example, an air gap therebetween.

The rotor assembly 100 is configured to be rotatable about the central axis 102. As shown in FIG. 2, the rotor assembly 100 may be implemented as multiple rotor segments 111, 112 forming the rotor core 104. The multiple rotor segments 111, 112 are arranged in an axially stacked relationship. For example, the first rotor segment 111 and the second rotor segment 112 are stacked alternately along the central axis 102. The multiple rotor segments 111, 112 may be, for example, but not limited to, a permanent magnet rotor segment, a reluctance rotor segment, or combination thereof. As shown in FIG. 2, each of the first type rotor segment 111 and the second type rotor segment 112 may be formed as a single piece. Alternatively, the first type rotor segment 111 and the second type rotor segment 112 may be implemented as multiple laminations, respectively. Any number of segments and laminations in a given design may be used, depending on design choice.

The multiple rotor segments 111, 112 may be step-skewed from each other to reduce torque ripple and cogging torque, although not required. FIG. 2 illustrates four multiple rotor segments 111, 112, but the rotor assembly 100 may include two, six, eight or more rotor segments in other embodiments.

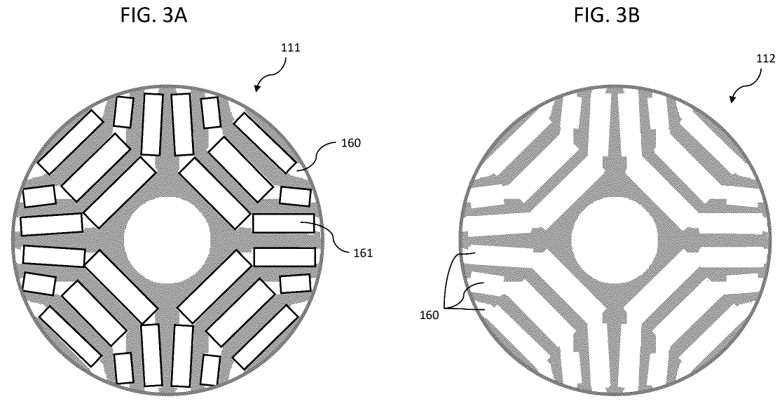

For example, referring to FIGS. 3A and 3B, the first type rotor segment 111 may be a permanent-magnet-assist reluctance type rotor segment (e.g. a multi-barrier permanent magnet assist reluctance rotor segment) including permanent magnets, while the second type rotor segment 112 may be a reluctance type rotor segment (e.g. a magnet free multi-barrier reluctance rotor) having no magnet.

The reluctance rotor segments 111, 112 operably associated with the stator assembly 500 may be configured to generate rotor torque through magnetic reluctance. The reluctance rotor segments 111, 112 may be constructed with one or more flux barriers 160 to induce non-permanent magnetic poles by increasing the reluctance (i.e. the capability of opposing the magnetic flow passage) along some direction, favoring instead others (i.e. the paths more characterized by the presence of iron). The flux barrier 160 may have various configurations such as, for example, but not limited to, a V-type, a spoke-type, a bar-type, an I-type, any appropriate type, or combination thereof, although the flux barrier 160 can have any shape for a necessary operation of the motor 50. The flux barriers 160 may be an air gap. Non-magnetic material (e.g. nylon, epoxy, potting material or other filler material) could be positioned or injected into the flux barriers 160 to increase the mechanical strength of the reluctance rotor segments 111, 112. The second reluctance rotor segment 112 may not comprise any magnetic material such as permanent magnets.

However, one or more magnetic materials 161 may be disposed in the flux barrier 160 of the first reluctance rotor segment 111. The magnetic materials 161 may be, for example, but not limited to, a ferrite magnet, rare-earth material such as Neodymium (Nd), Praseodymium Neodymium (PrNd), Dysprosium (Dy), Terbium (Tb), a rare earth permanent magnet (e.g. samarium cobalt (Sm—Co) magnet or neodymium iron boron (Nd—Fe—B) magnet) and so on. Alternatively, neither the first reluctance rotor segment 111 nor the second reluctance rotor segment 112 may have rare-earth material to reduce the manufacturing cost of the motor and avoid the risk of unstable supply of the rare-earth material.

The first reluctance type rotor segment 111 (or the second reluctance type rotor segment 112) can provide reverse ripple against the torque ripple generated by the second reluctance rotor segment 112 (or the first reluctance rotor segment 111) in order to effectively cancel the cogging torque generated by the second reluctance type rotor segment 112 (or the first reluctance type rotor segment 111).

The reluctance rotor segments 111, 112 may be a synchronous reluctance type rotor. The synchronous reluctance type rotor is configured to rotate by a toque generated due to the inequality of permeance (or magnetic conductivities) by quadrature and direct axes of the rotor. The synchronous reluctance type rotor may have poles with an equal number of stator poles. The synchronous reluctance type rotor may operate at synchronous speeds without current-conducting parts. However, the reluctance rotor segment 111, 112 may be implemented as various types, for example, but not limited to, variable reluctance rotor, switched reluctance rotor, variable stepping reluctance rotor, and any appropriate reluctance type rotor.

Referring back to FIG. 1, the stator assembly 500 includes a stator core 510 (e.g. iron core). The stator core 510 may be generally cylindrical in shape and extends along the central axis 102. The stator core 510 may include a substantially circular outer surface. As shown in FIG. 2, the stator assembly 500 may be implemented as multiple stator laminations 503 forming the stator core 510. The multiple stator laminations 503 are arranged in an axially stacked relationship. For example, the multiple stator laminations 503 are stacked along the central axis 102. Any number of laminations in a given design may be used, depending on design choice.

The inner surface 505 of the stator core 510 may be formed by a plurality of stator teeth 520. The stator teeth 520 may be arranged circumferentially and may protrude toward the rotor assembly 100. The inner surface 505 of the stator core 510 may form a cavity within the stator assembly 500 that is configured to receive the rotor assembly 500.

The stator slots 530 may be formed in the stator core 510 of the stator assembly 500. The stator core 510 defines stator slots 530 (e.g. 1 to 24) circumferentially arranged and extending outwardly from the inner surface 505 of the stator core 510 and lengthwise along the central axis 102. The stator slots 530 may be defined by the adjacent pair of stator teeth 520 that form the respective slot. The stator slots 530 may be evenly spaced from each other radially around the circumferential of the stator core 510. The stator slots 530 may be formed substantially in parallel to each other. The stator assembly 500 may include any number of slots or poles suitable to the application at hand. In the exemplary embodiment illustrated in FIG. 1, the stator core 510 defines twenty four (24) slots (FIG. 1 shows stator slot numbers 1 through 24) and has four (4) poles, but the stator core 510 may include more or fewer slots and/or poles in other embodiments.

The stator slots 530 may be designed and dimensioned to receive electrical conductors 540. The conductors 540 may be placed in the stator slots 530 to form electromagnetic windings. For example, the conductors 540 may extend in the axial direction through the stator slots 1 to 24 or be disposed about or in (e.g., wound or slid about) the teeth 520 of the stator core 510. The stator slots 1 to 24 may have partially open slots such that small openings to the stator slots 520 are provided along the inner surface 505 of the stator core 510. Alternatively, the stator slots 530 may be closed slots so that an inner wall of the stator core 510 can surround the conductors 540. A winding arrangement for the conductors 540 can carry an excitation current. Current flowing through the conductors 540 generates a stator electromagnetic flux. The stator flux may be controlled by adjusting the magnitude and frequency of the current flowing through the conductors 540.

The conductor 540 of the stator assembly 500 may comprise a plurality of stator windings 715 (e.g., 715a-1, . . . , 715a-M and 715b-1, . . . , 715b-M). The stator windings are constructed from, for example, but not limited to, a bar-type conductor, a wire-type conductor, and a hairpin-type conductor.

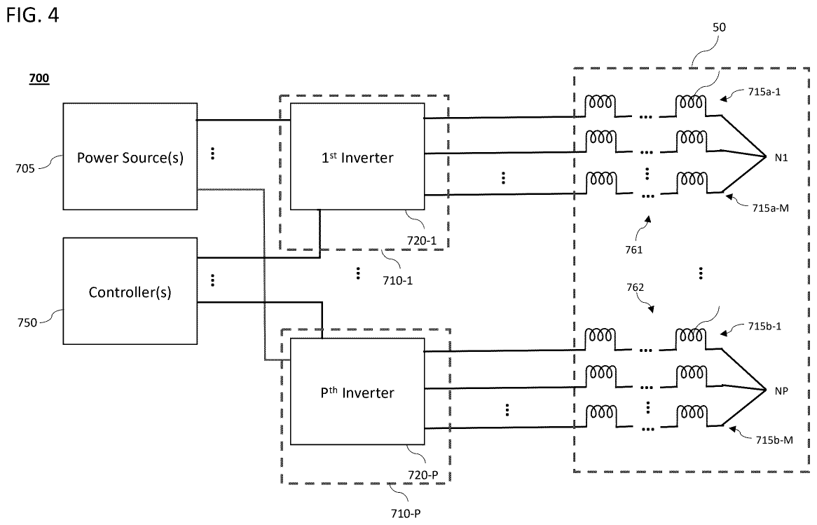

FIG. 4 is a schematic diagram of a motor system according to an embodiment of the present disclosure.

One or more power sources 705 are configured to supply power to a plurality of drives (or drivers) 710-1 to 710-P configured to drive the motor 50 (P is a positive integer). The power source 705 may be a direct current (DC) source. For example, the power source 705 may be a battery. However, single and multi-phase alternating current (AC) outputs may be also possible. Each of the drives 710-1 to 710-P includes one or more inverters or any one or more electric components or circuits which are capable of supplying currents to the motor 50 (e.g. stator windings 715 of the stator assembly 500). For example, one or more power sources 705 supply power to a plurality of inverters 720-1 to 720-P included in the plurality of the drives 710-1 to 710-P (P is a positive integer).

The multi-phase (M-phase) motor 50 comprises a first group 761 of first stator windings 715a-1 to 715a-M and a second group 762 of second stator windings 715b-1 to 715b-M (M is a positive integer more than 1). For instance, the motor 50 may be a three-phase motor having U-phase stator windings 715a-1, 715b-1, V-phase stator windings 715a-2, 715b-2, and W-phase stator windings 715a-3, 715b-3, and the U-phase winding 715a-1 or 715b-1, the V-phase winding 715a-2 or 715b-2, and the W-phase winding 715a-3 or 715b-3 are connected to parallel to each other, but it should be appreciated that embodiments of the present disclosure should not be limited to such. One having ordinary skill in the art would understand that the present disclosure can be implemented with a two-phase motor or a more than three-phase motor.

The plurality of inverters 720-1 to 720-P (P is a positive integer two (2) or more) receive power from one or more power sources 705, and convert DC voltages provided from the power source(s) 705 to AC voltages. The outputs generated by the inverters 720-1 to 720-P are applied to the stator windings 715 to drive the multi-phase (M-phase) motor 50.

One or more controllers 750 are configured to control the drives 710-1 to 710-P. For example, one or more controllers 750 generate gate signals for the inverters 720-1 to 720-P included in the drives 710-1 to 710-P. Accordingly, the control of the motor 50 is performed by regulating the voltage or the flow of current from the inverters 720-1 to 720-P through the stator windings 715 of the motor 50. There are many control schemes that can be used. The controller(s) 750 may have, for example, but not limited to, one or more of a circuit, microprocessor or computer, which monitors and physically alters the operating conditions of the motor system 700. The controllers 750 may also be configured to accept input and output from a wide array of input and output devices for receiving or sending values.

As illustrated in FIG. 4, for example, the motor system 700 may comprise the first inverter 720-1 and the second inverter 720-2. The first group 761 of the conductor windings 400 (e.g. first stator windings 715a-1 to 715a-M) is connected to the first inverter 720-1 and a first neutral point N1. Each of the first stator windings 715a-1 to 715a-M is configured for a respective phase. For example, first-phase first stator windings 715a-1 are configured for a first phase (e.g. U phase), second-phase first stator windings 715a-2 are configured for a second phase (e.g. V phase), and third-phase first stator windings 715a-3 are configured for a third phase (e.g. W phase). The second group 762 of the conductor windings 400 (e.g. second stator windings 715b-1 to 715b-M) is connected to the second inverter 720-2 and a second neutral point N2. Each of the second stator windings 715b-1 to 715b-M is configured for a respective phase. For example, first-phase second stator windings 715b-1 are configured for a first phase (e.g. U phase), second-phase second stator windings 715b-2 are configured for a second phase (e.g. V phase), and third-phase second stator windings 715b-3 are configured for a third phase (e.g. W phase).

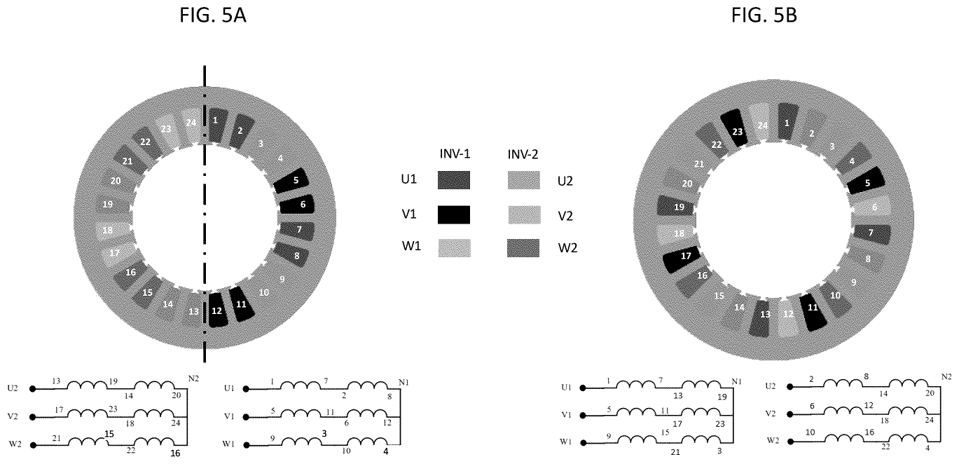

In a first exemplary embodiment of the present disclosure illustrated in FIG. 5A, the first stator windings 715a-1 to 715a-M of the first group 761 connected to the first inverter 720-1 are consecutively positioned in a half of the stator slots 530, and the second stator windings 715b-1 to 715b-M of the second group 762 connected to the second inverter 720-2 are consecutively positioned in the other half of the stator slots 530. Numbers 1 to 24 in FIG. 5A are a stator slot number, represented in FIG. 1, and characters U, V, W in FIG. 5A indicate a motor phase. In FIG. 5A, the number positioned left of the stator winding is a go slot (or a return slot) and the number positioned right of the stator winding is a return slot (or a go slot). In the first exemplary embodiment of the present disclosure shown in FIG. 5A, the stator slots 530 are grouped into a first group 761 of stator slots 1 to 12, which is a half of the stator slots 530 consecutively positioned, and a second group 762 of stator slots 13 to 24, which is the other half of the stator slots 530 consecutively positioned. The first group 761 of the first stator windings 715a-1 to 715a-M inserted in the first group of stator slots 1 to 12, which is located at the right half of the stator core 510, are connected to the first inverter 720-1, and the second group 762 of the second stator windings 715b-1 to 715b-M inserted in the second group of stator slots 13 to 24, which is located at the left half of the stator core 510, are connected to the second inverter 720-2. Currents for both the first and second inverters 720-1 and 720-2 may be in phase such as zero degree phase shift between the first and second inverters 720-1 and 720-2.

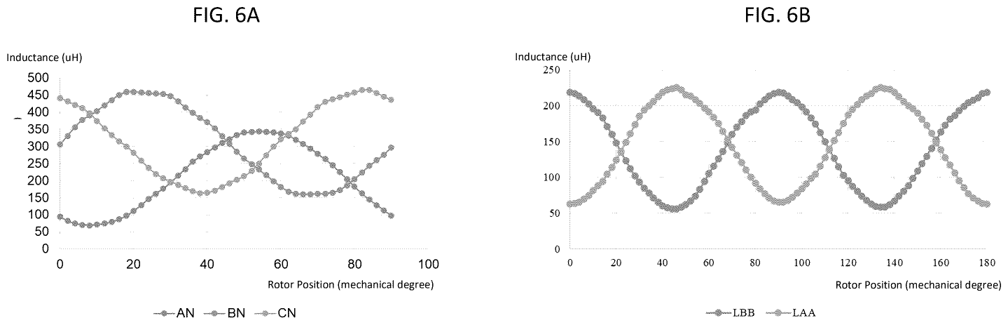

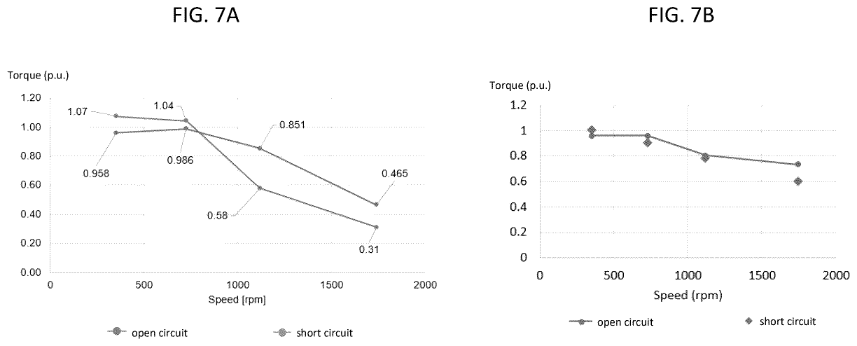

However, when the stator wiring configuration described above according to the first exemplary embodiment of the present disclosure shown in FIG. 5A is under open or short fault in at least one of the inverters 720-1 to 720-P, it may cause unbalanced inductance as shown in FIG. 6A, control issues due to higher phase voltage requirements, and a lower or limited output torque (e.g. a 15-20% output torque) as shown in FIG. 7A. Specifically, in the first exemplary embodiment of FIG. 5A, during a fault condition (such as open or single FET short) in at least one of the inverters 720-1 to 720-P, no mutual coupling from a faulty inverter during the open may result in unbalance in induction among normal inverters, a short circuit current may flow in the motor 50 thereby contributing to the drag torque, and less magnetic saturation of a normal inverter may be caused. Due to the inductance unbalance in inverters with normal phases, higher voltage may be required to control the current, and therefore the output torque may be limited during the fault condition.

To solve these problems of the first exemplary embodiment described above, a second exemplary embodiment of the present disclosure has stator winding arrangement in which each of the plurality of drives such as inverters is evenly or balancedly connected to one of the plurality of stator windings 540 over the circumference of the stator core 510. Each of the plurality of drives may be connected to at least one of stator windings 540 located at one half side of the stator core 510 and each of the plurality of motor drives may be connected to at least one of stator windings 540 located at the other half side of the stator core 510. For example, each of the plurality of drives may be evenly connected to stator windings 540 located at one half side of the stator core 510 and each of the plurality of drives may be evenly connected to stator windings 540 located at the other half side of the stator core 510. As another example, adjacently positioned stator windings 540 are not connected to a same inverter, and are connected to different inverters, respectively. For example, the first stator windings 715a-1 to 715a-M of the first group 761 connected to the first inverter 720-1 are not consecutively arranged, and the second stator windings 715b-1 to 715b-M of the second group 762 connected to the second inverter 720-2 are not consecutively disposed. In other words, any two of the first stator windings 715a-1 to 715a-M connected to the first inverter 720-1 are not inserted in adjacently positioned stator slots 530, respectively, and any two of the second stator windings 715b-1 to 715b-M of the second group 762 connected to the second inverter 720-2 are not inserted in adjacently positioned stator slots 530, respectively. Rather, each one of the first stator windings 715a-1 to 715a-M of the first group 761 connected to the first inverter 720-1 and each one of the second stator windings 715b-1 to 715b-M of the second group 762 connected to the second inverter 720-2 are alternatively disposed in the stator slots 530 so that any two consecutively positioned stator windings 540 disposed in two adjacently located stator slots 530, respectively, cannot be connected to the same inverter (i.e. one of the first inverter 720-1 and the second inverter 720-2), and can be connected to the first inverter 720-1 and the second inverter 720-2, respectively.

In the second exemplary embodiment of the present disclosure, two adjacently positioned stator windings 540 (e.g. stator windings positioned in stator slots 1 and 2) are connected to one inverter (e.g. the first inverter 720-1) and another inverter (e.g. the second inverter 720-2), respectively. For example, a first stator winding disposed in one of two adjacently positioned stator slots 530 (e.g. a stator winding positioned in a stator slot 1) is connected to the first inverter 720-1, while a second stator winding positioned in the other of two adjacently positioned stator slots 530 (e.g. a stator winding positioned in a stator slot 2) is connected to the second inverter 720-2.

And, two stator windings 540 (e.g. stator windings located in stator slots 2 and 4) disposed adjacent to one stator winding 540 (e.g. a stator winding located in a stator slot 3) are connected to one or more inverters other than an inverter to which the one stator winding 540 (e.g. a stator winding located in a stator slot 3) is connected.

In a first example of the second exemplary embodiment of the present disclosure, both two stator windings 540 (e.g. stator windings located in stator slots 2 and 4) disposed adjacent to one stator winding 540 (e.g. stator windings located in a stator slot 3) connected to the first inverter 720-1 are connected to the same inverter such as one second inverter 720-2 to which the one stator winding 540 (e.g. a stator winding located in a stator slot 3) is not connected.

In a second example of the second exemplary embodiment of the present disclosure, two stator windings 540 (e.g. stator windings located in stator slots 2 and 4), disposed adjacent to one stator winding 540 (e.g. a stator winding located in a stator slot 3) connected to the first inverter 720-1, are connected to different inverters, for example, a second inverter 720-2 and a third inverter 720-3, respectively, to which the one stator winding 540 (e.g. a stator winding located in a stator slot 3) is not connected.

Accordingly, the stator winding 540 positioned in the stator slot 3 is connected to the first inverter 720-1, while adjacent other stator windings 540 arranged in the stator slots 2 and 4 positioned adjacent to the stator slot 3 are connected to the second inverter 720-2, or the second inverter 720-2 and the third inverter 720-3, which is or are not an inverter to which the stator winding 540 positioned in the stator slot 3 is connected. Thus, according to the second exemplary embodiment of the present disclosure, no stator windings from consecutive stator slots are connected to the same inverter.

First stator windings connected to the first inverter 720-1, second stator windings connected to the second inverter 720-2, . . . and P-th stator windings connected to the P-th inverter 720-P are arranged to alternate with each other in the stator slots 530 so that none of adjacently positioned stator windings can be connected to the same inverter, and adjacently positioned stator windings can be connected to different inverters, respectively.

The first stator windings 715a-1 to 715a-M of the first group 761 connected to the first inverter 720-1 and the second stator windings 715b-1 to 715b-M of the second group 762 connected to the second inverter 720-2 are configured for multi-phases such as a U phase, V phase, and W phase. Stator windings configured for the same phase may be evenly spaced apart from each other radially around the circumferential of the stator core 510. For example, first stator windings connected to the first inverter 720-1 and configured for the U phase are inserted in stator slots 1, 7, 13, and 19 at a regular interval, first stator windings connected to the first inverter 720-1 and configured for W phase are equally spaced apart each other by being disposed in stator slots 3, 9, 15, and 21, and first stator windings connected to the first inverter 720-1 and configured for V phase are evenly disposed in slots 5, 11, 17, and 23. And, second stator windings connected to the second inverter 720-2 and configured for U phase inserted in slots 2, 8, 14, and 20 at a regular interval, second stator windings connected to the second inverter 720-2 and configured for W phase are equally spaced apart each other by being disposed in slots 4, 10, 16, and 23, and second stator windings connected to the first inverter 720-1 and configured for V phase are evenly disposed in slots 6, 12, 18, and 24.

Dual-inverter three-phase configuration of connection and arrangement of stator windings according to the second embodiment of the present disclosure is shown in FIG. 5B. FIG. 5B is a conceptual diagram for schematically illustrating connection and arrangement of stator windings connected between the first and second inverters 720-1 and 720-2 and motor neutral points N1 and N2 according to the second embodiment of the present disclosure. Numbers 1 to 24 in FIG. 5B are a stator slot number, represented in FIG. 1, and characters U, V, W in FIG. 5B indicate a motor phase. In FIG. 5B, the number positioned left of the stator winding is a go slot (or a return slot) and the number positioned right of the stator winding is a return slot (or a go slot). In the dual-inverter three-phase configuration according to the second embodiment of the present disclosure, first stator windings inserted in odd-numbered stator slots 1, 3, . . . , 21, 23 are connected to the first inverter 720-1, and second stator windings inserted in even-numbered stator slots 2, 4, . . . ,22, 24 are connected to the second inverter 720-2 such that adjacently positioned stator windings cannot be connected to the same inverter, and can be connected to different inverters, respectively. A first group of a first stator winding disposed in a stator slot 1 and a second winding disposed in a stator slot 2, which are connected to the first inverter 720-1 and the second inverter 720-2, respectively, is configured for U phase, a second group of a first stator winding disposed in a stator slot 3 and a second winding disposed in a stator slot 4, which are connected to the first inverter 720-1 and the second inverter 720-2, respectively, is configured for V phase, a third group of a first stator winding disposed in a stator slot 5 and a second winding disposed in a stator slot 6, which are connected to the first inverter 720-1 and the second inverter 720-2, respectively, is configured for W phase, and those first, second third groups are repeated in turn, so that stator windings configured for the same phase can be evenly spaced apart from each other. Therefore, first stator windings disposed in stator slots 1, 7, 13, and 19 are connected to the first inverter 720-1 and configured for U phase, first stator windings disposed in stator slots 3, 9, 15, and 21 are connected to the first inverter 720-1 and configured for W phase, and first stator windings disposed in slots 5, 11, 17, and 23 are connected to the first inverter 720-1 and configured for V phase. Second stator windings disposed in slots 2, 8, 14, and 20 are connected to the second inverter 720-2 and configured for U phase, second stator windings disposed in slots 4, 10, 16, and 23 are connected to the second inverter 720-2 and configured for W phase, and second stator windings disposed in slots 6, 12, 18, and 24 are connected to the first inverter 720-1 and configured for V phase.

Therefore, according to the second embodiment of the present disclosure, stator windings can be arranged equally and balancedly based on the connection of stator windings to different drives such as inverters and multiple motor phases configured for each stator winding.

While in the first embodiment of the present disclosure shown in FIG. 5A currents through the first and second inverters 720-1 and 720-2 are with zero (0) degree phase shift between the first and second inverters 720-1 and 720-2, currents though the first and second inverters 720-1 and 720-2 according to the second embodiment of the present disclosure shown in FIG. 5B are with a phase shift of 0≤ϕ≤180 between the first and second inverters 720-1 and 720-2 such that the average torque of the motor 50 can be increased, and the torque ripple and core loss of the motor 50 can be reduced. The preferred phase shift according to the second embodiment of the present disclosure may be around 30 degrees, although not required.

The second embodiment of the present disclosure illustrated in FIG. 5B has stator winding arrangement in which no stator windings from consecutive stator slots are connected to the same inverter, and therefore the motor 50 may have stator windings distributed spatially over 360 degrees resulting in a balanced magnetic circuit. Thus, according to the second embodiment of the present disclosure illustrated in FIG. 5B, under open or short fault in one of the inverters 720-1 to 720-P, stator winding configuration in which adjacently positioned stator windings are connected to different inverters, respectively, may maintain balanced inductance for normal (or healthy) phases as shown in FIG. 6B as the stator windings are distributed spatially over 360 degrees and can generate 35% or more output torque as shown in FIG. 7B, and no control issue may occur, and thus the problem of higher voltage requirement under the fault according to the first embodiment of FIG. 5A can be solved. Further, under normal or healthy operating condition, the stator winding arrangement and configuration according to the second embodiment of FIG. 5B can increase the output torque of the motor 50 by 2-10%. The second embodiment of the present disclosure illustrated in FIG. 5B can have the same dominant noise, vibration, and harshness (NVH) mode order even during the fault condition of the motor 50.

The motor 50 according to certain exemplary embodiments of the present disclosure may be employed in a vehicle 800. The vehicle 800 may be any passenger or commercial automobile such as a hybrid vehicle, an electric vehicle, or any other type vehicles. FIG. 8 is a schematic view of a vehicle including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 (e.g. the motor 50 described above) and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor (e.g. the motor 50 described above) which is connected to the steering shaft or steering column 822. The feedback actuator or steering feel actuator 828 provides the driver or operator with the same “road feel” that the driver receives with a direct mechanical link.

Although the embodiment illustrated in FIG. 8 shows the vehicle having the steer-by-wire steering system, the motor 50 according to exemplary embodiments of the present disclosure can be used in a vehicle having a mechanical steering system. The mechanical steering system typically includes a mechanical linkage or a mechanical connection between the steering wheel 820 and the road wheels 830. In the mechanical steering system, the steering actuator motor 834 includes an electric motor (e.g. the motor 50 described above) to provide power to assist the movement of the road wheels 830 in response to the operation of the driver or a control signal of the controller 850.

Accordingly, the motor 50 according to some embodiment of the present disclosure can be used as the steering actuator motor 834 or can be included in the feedback actuator or steering feel actuator 828.

The motor 50 can be employed in an electromagnetic brake assembly 860. The electromagnetic brake assembly 860 is configured to cause the road wheel 830 to slow or stop motion using electromagnetic force to apply mechanical resistance or friction by using the torque generated by the motor 50.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A motor system comprising:
a plurality of drives configured to drive a plurality of stator windings;
a stator assembly comprising the plurality of stator windings arranged along a circumference of a stator core, wherein each of the plurality of drives is evenly connected to one of the plurality of stator windings over the circumference of the stator core; and
a rotor assembly configured to be rotatable relative to the stator assembly.

2. The motor system of claim 1, wherein each of the plurality of drives comprises an inverter.

3. The motor system of claim 1, wherein each of the plurality of drives is connected to at least one of stator windings located at one half side of the stator core among the plurality of stator windings and each of the plurality of motor drives is connected to at least one of stator windings located at another half side of the stator core among the plurality of stator windings.

4. The motor system of claim 1, wherein adjacently positioned stator windings among the plurality of stator windings are connected to different drives, respectively, among the plurality of motor drives.

5. The motor system of claim 1, wherein:
the stator assembly includes a stator core having a plurality of stator slots, and
one of the stator windings at least partially disposed in one of the stator slots is connected to one of the plurality of drives which is not connected to two others of the stator windings at least partially disposed in two others of the stator slots located adjacent to the one of the stator slots.

6. The motor system of claim 1, wherein the plurality of stator windings are configured to multi-phases, and stator windings configured for a same phase among the plurality of stator winding are evenly spaced apart from each other.

7. The motor system of claim 1, wherein:
the plurality of drives comprise first and second drives,
the plurality of stator windings comprise first stator windings connected to the first drive and second stator windings connected to the second drive, and
the first stator windings connected to the first drive and the second stator windings connected to the second drive are alternatively disposed.

8. The motor system of claim 1, wherein:
the plurality of drives comprise first and second motor drives,
the plurality of stator windings are configured for three phases including first, second, and third phases, and
a first winding connected to the first drive and configured for the first phase, a second winding connected to the second drive and configured for the first phase, a third winding connected to the first drive and configured for the second phase, a fourth winding connected to the second drive and configured for the second phase, a fifth winding connected to the first drive and configured for the third phase, and a sixth winding connected to the second drive and configured for the third phase are arranged in turn repeatedly in a stator core of the stator assembly.

9. The motor system of claim 1, wherein the rotor assembly comprises a plurality of reluctance rotor segments including a first reluctance rotor segment and a second reluctance rotor segment which are axially stacked relative to each other.

10. The motor system of claim 9, wherein one or more flux barriers included in the first reluctance rotor segment have different shapes from one or more flux barriers included in the second reluctance rotor segment.

11. The motor system of claim 9, wherein:
the first reluctance rotor segment includes one or more permanent magnets in one or more flux barriers included in the first reluctance rotor segment, and
the second reluctance rotor segment does not include the one or more permanent magnets in one or more flux barriers included in the second reluctance rotor segment.

12. The motor system of claim 9, wherein material different from a rotor core of the second reluctance rotor segment is disposed in one or more flux barriers included in the second reluctance rotor segment.

13. The motor system of claim 9, wherein the second reluctance rotor includes one or more flux barriers formed with an air gap.

14. The motor system of claim 1, wherein the plurality of driver are configured to provide currents, which are with a phase shift between each other, to the plurality of stator windings.

15. The motor system of claim 1, wherein adjacently positioned stator windings among the plurality of stator windings are not connected to a same drive among the plurality of drives.

16. The motor system of claim 15, wherein currents of the adjacently positioned stator windings not connected to the same driver have a phase shift between each other.

17. A vehicle comprising:
one or more road wheels configured to cause the vehicle to move;
a steering wheel configured to generate an input for controlling the one or more road wheels;
a brake assembly configured to operate a vehicle brake associated with the one or more road wheels; and
one or more motors operatively connected to one or more of the one or more road wheels, the steering wheel and the brake assembly, at least one of the motors comprising:
a plurality of drives configured to drive a plurality of stator windings;
a stator assembly comprising the plurality of stator windings arranged along a circumference of a stator core, wherein each of the plurality of drives is evenly connected to one of the plurality of stator windings over the circumference of the stator core; and
a rotor assembly configured to be rotatable relative to the stator assembly.
